(19) United States
(12) Patent Application Publication
(10) Pub. No.: US 2010/0002880 A1
(43) Pub. Date: Jan. 7, 2010

(54) SYSTEM AND METHOD FOR LAWFUL INTERCEPTION USING TRUSTED THIRD PARTIES IN SECURE VoIP COMMUNICATIONS

(75) Inventors: Seok Ung Yoon, Seongnam-si (KR); Joong Man Kim, Namyangju-si (KR); Yong Geun Won, Seoul (KR); Yoo Jae Won, Yongin-si (KR); Hyun Cheol Jeong, Seoul (KR)

Correspondence Address: Charles N. J. Ruggiero;Ohlandt, Greeley, Ruggiero & Perle, L.L.P., 10th Floor, One Landmark Square, Stamford, CT, 06901-2682, US

(73) Assignee: Korea Information Security Agency

(21) Appl. No.: 12/181,543

(22) Filed: Jul. 29, 2008

(30) Foreign Application Priority Data
Nov. 21, 2007 (KR) 10-2007-0119164

(51) Int. Cl. H04L 9/08; H04K 1/00; H04L 9/00

(52) U.S. Cl. 380/255; 380/44; 380/279

(57) ABSTRACT

Disclosed is a system for lawful interception using a trusted third party in secure VoIP communication. A VoIP transmit terminal generates a secure packet using a master key received from a trusted third party and then communicates with a VoIP receive terminal. A collection device having received a lawful interception instruction from a key recovering system collects and transmits the secure packet to the key recovering system. The key recovering system decrypts the secure packet using the master key received from the trusted third party and provides the decrypted secure packet to a lawful interception requester or provides the master key received from the trusted third party and the secure packet to the lawful interception requester. It is possible to provide the perfect lawful interception in the secure VoIP communication environment, and to guarantee a perfect forward secrecy since the master key is changed for each call.

### CROSS-REFERENCE TO RELATED APPLICATIONS

This application claims all benefits of Korean Patent Application No. 10-2007-0119164 filed on Nov. 21, 2007 in the Korean Intellectual Property Office, the disclosures of which are incorporated herein by reference.

### BACKGROUND

1. Technical Field

The present invention relates to a system and a method for lawful interception using a trusted third party in secure VoIP (Voice Over Internet Protocol) communication. According to the invention, a VoIP transmit terminal generates a secure packet using a master key received from a trusted third party and then communicates with a VoIP receive terminal. A collection device having received a lawful interception instruction from a key recovering system collects and transmits the secure packet to the key recovering system. The key recovering system decrypts the secure packet using the master key received from the trusted third party and provides the decrypted packet to a lawful interception requester or provides the master key received from the trusted third party and the secure packet to the lawful interception requester.

2. Description of the Related Art

Currently, a method for lawfully intercepting call contents between subscribers is widely used in the PSTN (Public Switched Telephone Network). In addition, as a VoIP for transmitting voice information using the IP (Internet Protocol) is widely used, a lawful interception method in the VoIP network is also suggested.

In the meantime, the trusted third party (TTP) means an institution that is trusted in a user authentication and a key management from users and performs mediation, authentication, verification, management and the like. The trusted third party to manage an encryption key for the purpose of secure communication in the VoIP network is occasionally used.

The conventional lawful interception method in the VoIP network is to lawfully intercept the general call in the VoIP. However, a technology that performs the lawful interception using the trusted third party has not been disclosed in the secure communication using the trusted third party.

### SUMMARY OF THE DISCLOSURE

Accordingly, the present invention has been made to solve the above problems. An object of the invention is to provide a system and a method for lawful interception using a trusted third party in secure VoIP communication. According to the invention, a VoIP transmit terminal generates a secure packet using a master key received from a trusted third party and then communicates with a VoIP receive terminal. During the communication, a collection device having received a lawful interception instruction from a key recovering system collects and transmits the secure packet to the key recovering system. The key recovering system decrypts the secure packet using the master key received from the trusted third party and provides the decrypted secure packet to a lawful interception requester or provides the master key received from the trusted third party and the secure packet to the lawful interception requester. By doing so, it is possible to provide the perfect lawful interception in the secure VoIP communication environment, and to guarantee a perfect forward secrecy since the master key managed by the trusted third party is changed for each call.

To be more specific, the invention relates to a system for lawful interception using a trusted third party in secure VoIP communication. The system is for lawfully intercepting secure communication using a trusted third party between a VoIP transmit terminal and a VoIP receive terminal and comprises a trusted third party that receives a master key request from the VoIP transmit terminal to generate a master key and transmits the generated master key to the VoIP transmit terminal and a key recovering system; a key recovering system that receives a lawful interception request from a lawful interception requester to instruct a collection device on lawful interception, receives a secure packet from the collection device, receives the master key from the trusted third party, decrypts the secure packet with the master key and provides the decrypted packet to the lawful interception requester or provides the master key and the secure packet to the lawful interception requester; and a collection device that collects the secure packet transmitted/received between the VoIP transmit terminal and the VoIP receive terminal in accordance with the lawful interception instruction received from the key recovering system and transmits the collected secure packet to the key recovering system.

In addition, the invention relates to a method for lawful interception using a trusted third party in secure VoIP communication. The method is for lawfully intercepting secure communication using a trusted third party between a VoIP transmit terminal and a VoIP receive terminal and comprises the steps of: (a) instructing, at a key recovering system, a collection device on lawful interception in accordance with a lawful interception request from a lawful interception requester; (b) at the trusted third party, receiving a master key request from the VoIP transmit terminal to generate a master key and transmitting the generated master key to the VoIP transmit terminal; (c) exchanging the master key and performing secure communication between the VoIP transmit terminal and the VoIP receive terminal; (d) at the collection device, collecting a secure packet transmitted/received between the VoIP transmit terminal and the VoIP receive terminal and transmitting the secure packet to the key recovering system; and (e) at the key recovering system, receiving the master key from the trusted third party, decrypting the secure packet with the received master key and providing the decrypted packet to the lawful interception requester.

### BRIEF DESCRIPTION OF THE DRAWINGS

The above and other objects, features and advantages of the present invention will be more apparent from the following detailed description taken in conjunction with the accompanying drawings, in which:

FIG. 1 shows a structure of a system for lawful interception using a trusted third party in secure VoIP communication according to an embodiment of the invention;

FIG. 2 shows a detailed structure of a trusted third party according to an embodiment of the invention;

FIG. 3 shows a detailed structure of a key recovering system according to an embodiment of the invention;

FIG. 4 is a flow chart showing a process for lawful interception using a trusted third party in secure VoIP communication according to an embodiment of the invention; and

FIG. 5 is a flow chart showing a process for lawful interception using a trusted third party in secure VoIP communication according to another embodiment of the invention.

### DETAILED DESCRIPTION OF THE INVENTION

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

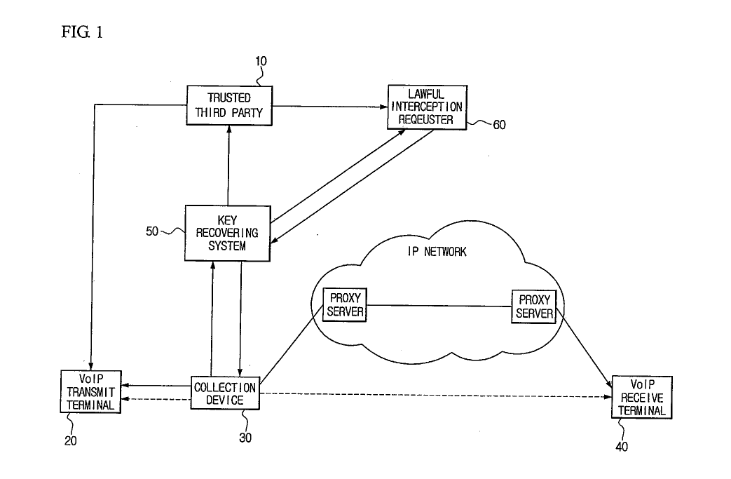

FIG. 1 shows a structure of a system for lawful interception using a trusted third party in secure VoIP communication according to an embodiment of the invention.

The system for lawful interception according to the invention comprises a trusted third party 10, a VoIP transmit terminal 20, a collection device 30, a VoIP receive terminal 40 and a key recovering system 50.

The trusted third party 10 is an institution that manages an encryption key for the purpose of secure communication between VoIP terminals.

According to an embodiment, when the trusted third party 10 receives a request for a master key (Traffic Generation Key; TGK) from the VoIP transmit terminal 20, which master key is a kind of an encryption key necessary for the secure communication with the VoIP receive terminal 40, the trusted third party 10 generates and then transmits a master key to the VoIP transmit terminal 20. In addition, the trusted third party 10 also transmits the master key to the key recovering system 50 so that the key recovering system 50 can decrypt a secure packet, as described below.

Alternatively, when the trusted third party 10 receives a request for a master key from the VoIP transmit terminal 20, which master key is a kind of an encryption key necessary for the secure communication with the VoIP receive terminal 40, the trusted third party 10 generates and then transmits a master key to the VoIP transmit terminal 20. Then, the trusted third party 10 may generate a session key from the master key and transmit the session key to the key recovering system 50. At this time, the session key is an encryption key that is used to actually encrypt a voice packet between the VoIP transmit terminal 20 and the VoIP receive terminal 40.

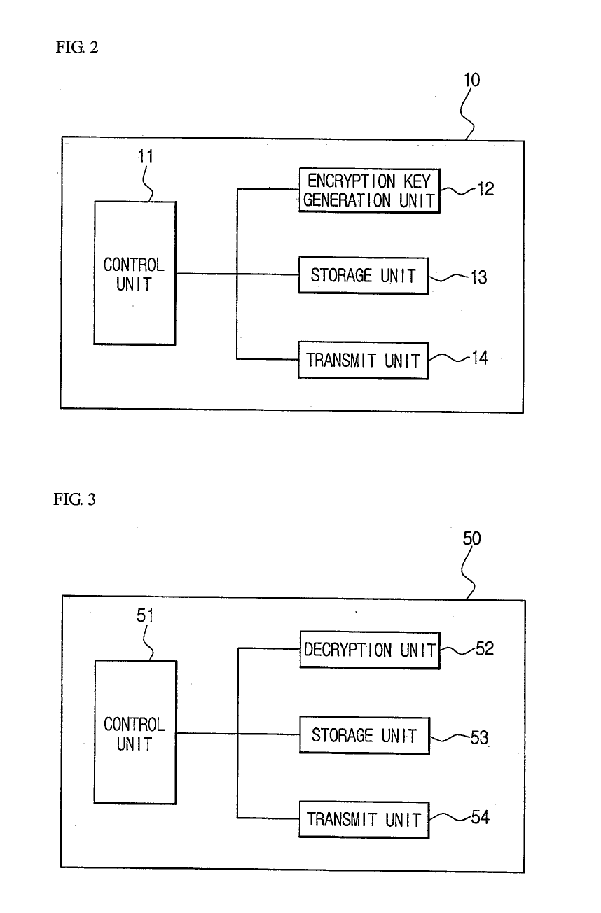

FIG. 2 shows a detailed structure of a trusted third party according to an embodiment of the invention. To be more specific, the trusted third party 10 comprises a control unit 11, an encryption key generation unit 12, a storage unit 13 and a transmit unit 14.

When there is a request for an encryption key from the VoIP transmit terminal 20, the encryption key generation unit 12 generates a master key under the control of control unit 11 and generates a session key from the master key.

The storage unit 13 stores the master key and the session key that are generated by the encryption key generation unit 12 under the control of control unit 11.

The transmit unit 14 transmits the master key and the session key to the VoIP transmit terminal 20 and the key recovering system 50 under the control of control unit 11, respectively.

The control unit 11 controls the respective elements constituting the trusted third party 10 and may perform additional functions such as key recovery request record management and monitoring management, as required.

The collection device 30 collects secure packets transmitted/received between the VoIP transmit terminal 20 and the VoIP receive terminal 40, which are the objects of the lawful interception, in accordance with a lawful interception instruction received from the key recovering system 50, and transmits the collected secure packets to the key recovering system 50.

The key recovering system 50 receives a request for lawful interception from the lawful interception requester 60 and instructs the collection device 30 on the lawful interception. In addition, the key recovering system 50 receives the secure packet from the collection device 30 and receives the master key or session key from the trusted third party 10. Then, the key recovering system decrypts the secure packets using the master key or session key and provides the decrypted packets to the lawful interception requester 60. Alternatively, the key recovering system 50 may provide the master key or session key received from the trusted third key 10 to the lawful interception requester 60 together with the secure packets so that the lawful interception requester 60 can decrypt the secure packets.

FIG. 3 shows a detailed structure of a key recovering system according to an embodiment of the invention. Specifically, the key recovering system 50 comprises a control unit 51, a decryption unit 52, a storage unit 53 and a transmit unit 54.

The decryption unit 52 decrypts the secure packets received from the collection device 30 using the master key or session key received from the trusted third party 10.

The storage unit 53 stores communication information between the VoIP transmit terminal 20 and the VoIP receive terminal 40 under the control of control unit 51. For example, the storage unit stores the information such as IDs of the transmit and receive terminals, IP/ports of the transmit and receive terminals, time at which a call is initiated and time at which the call is terminated. At this time, the communication information is extracted from the packets decrypted in the decryption unit 52.

The transmit unit 54 receives the secure packets from the collection device 30, receives the master key or session key from the trusted third key 10 and transmits the decrypted packets to the lawful interception requester 60.

The control unit 51 controls the respective elements constituting the key recovering system 50 and may perform additional functions such as key recovery request record management and monitoring management, as required.

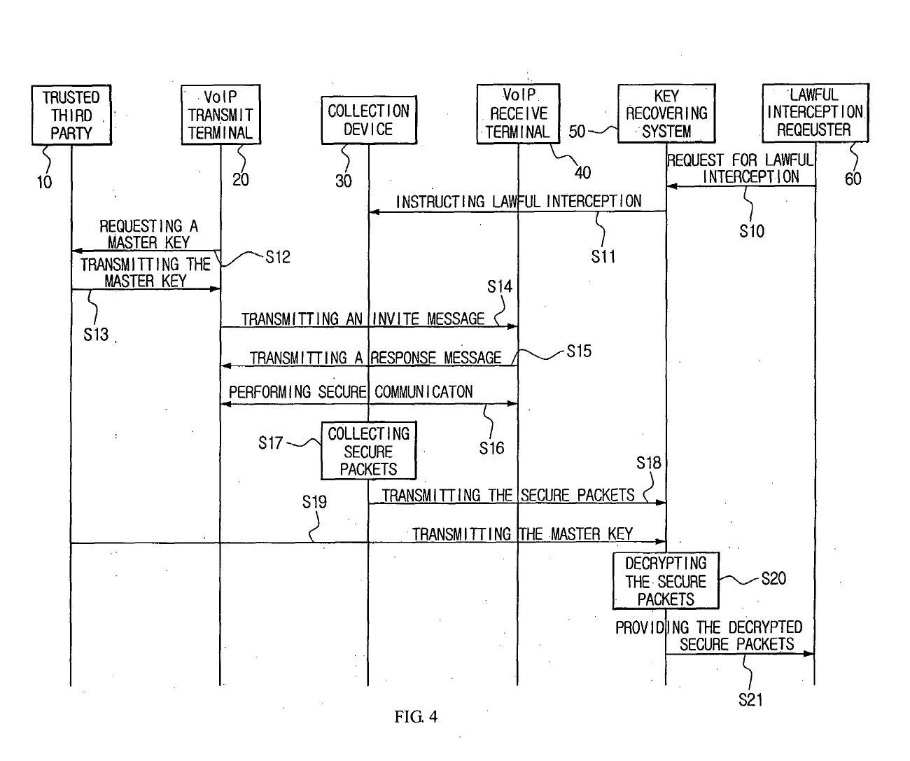

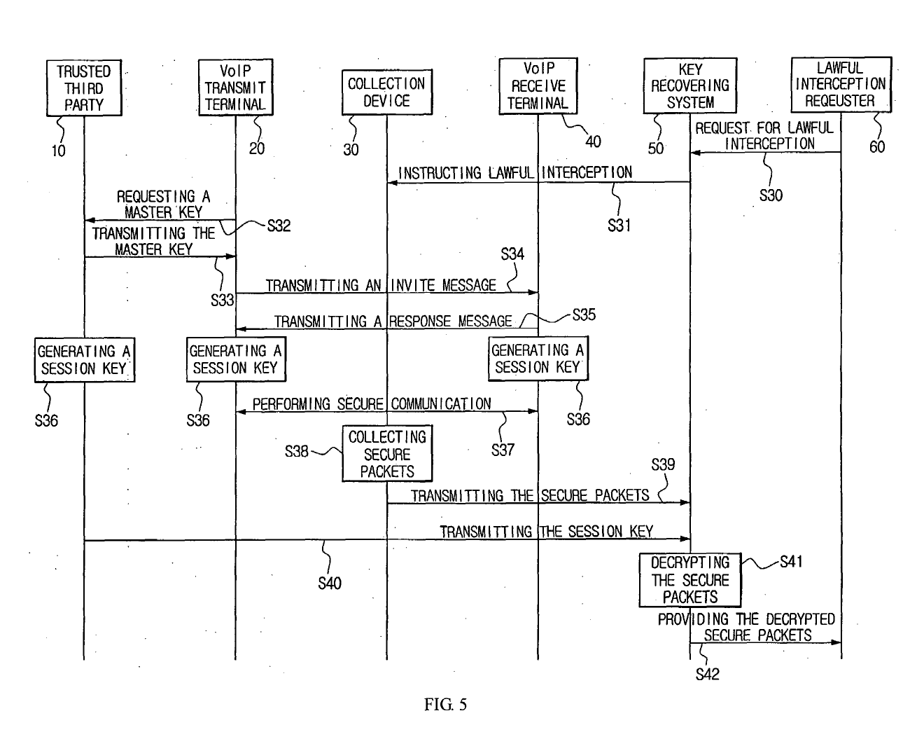

The following describes a method for lawful interception using a trusted third party in secure VoIP communication according to the invention, with reference to FIGS. 4 and 5.

FIG. 4 is a flow chart showing a process for lawful interception using a trusted third party in secure VoIP communication according to an embodiment of the invention.

First, the lawful interception requester 60 transmits the information about terminals that are objects of the lawful interception to the key recovering system 50 and requests the lawful interception (S10). The information may be for example, IDs of the transmit and receive terminals and IP/ports of the transmit and receive terminals. The key recovering system 50 having received the request for lawful interception transmits the information about the terminals that are objects of the lawful interception to the collection device 40, thereby instructing the lawful interception (S11).

Meantime, when the VoIP transmit terminal 20 requests the trusted third party 10 for a master key for the purpose of the secure communication with the VoIP receive terminal 40 (S12), the trusted third party 10 generates and then transmits a master key to the VoIP transmit terminal 20 (S13).

Then, when the VoIP transmit terminal 20 transmits an INVITE message including the master key to the VoIP receive terminal 40 so as to initiate the secure communication with the VoIP receive terminal 40 (S14), the VoIP receive terminal 40 transmits a response message to the VoIP transmit terminal 20 (S15), so that the secure communication between the VoIP transmit terminal 20 and the VoIP receive terminal 40 is made (S16).

Like this, during the secure communication between the VoIP transmit terminal 20 and the VoIP receive terminal 40, the collection device 30 collects the secure packets transmitted/received between the VoIP transmit terminal 20 and the VoIP receive terminal 40 (S17), which are the objects of the lawful interception, and transmits the collected secure packets to the key recovering system 50 (S18).

Then, the key recovering system 50 receives the master key from the trusted third party 10 (S19), decrypts the secure packets received from the collection device 30 using the master key in real time (S20) and provides the decrypted packets to the lawful interception requester 60 (S21).

Alternatively, after the step of S19, the key recovering system 50 may provide both the master key received from the trusted third party 10 and the secure packets received from the collection device 30 to the lawful interception requester 60 (not shown) so that the lawful interception requester 60 can directly decrypt the secure packets.

FIG. 5 is a flow chart showing a process for lawful interception using a trusted third party in secure VoIP communication according to another embodiment of the invention.

First, the lawful interception requester 60 transmits the information about terminals that are objects of the lawful interception to the key recovering system 50 and requests the lawful interception (S30). The information may be for example, IDs of the transmit and receive terminals and IP/ports of the transmit and receive terminals. The key recovering system 50 having received the request for lawful interception transmits the information about the terminals that are objects of the lawful interception to the collection device 30, thereby instructing the lawful interception (S31).

Meantime, when the VoIP transmit terminal 20 requests the trusted third party 10 for a master key for the purpose of the secure communication with the VoIP receive terminal 40 (S32), the trusted third party 10 generates and then transmits a master key to the VoIP transmit terminal 20 (S33).

Then, when the VoIP transmit terminal 20 transmits an INVITE message including the master key to the VoIP receive terminal 40 so as to initiate the secure communication with the VoIP receive terminal 40 (S34), the VoIP receive terminal 40 transmits a response message to the VoIP transmit terminal 20 (S35).

Then, the trusted third party 10, the VoIP transmit terminal 20 and the VoIP receive terminal 40 generate a session key from the master key, respectively (S36), so that the secure communication between the VoIP transmit terminal 20 and the VoIP receive terminal 40 is made (S37).

Like this, during the secure communication between the VoIP transmit terminal 20 and the VoIP receive terminal 40, the collection device 30 collects the secure packets transmitted/received between the VoIP transmit terminal 20 and the VoIP receive terminal 40 (S38), which are the objects of the lawful interception, and transmits the collected secure packets to the key recovering system 50 (S39).

Then, the key recovering system 50 receives the session key from the trusted third party 10 (S40), decrypts the secure packets received from the collection device 30 using the session key in real time (S41) and then provides the decrypted packets to the lawful interception requester 60 (S42).

Alternatively, after the step of S40, the key recovering system 50 may provide both the session key received from the trusted third party 10 and the secure packets received from the collection device 30 to the lawful interception requester 60 (not shown) so that the lawful interception requester 60 can directly decrypt the secure packets.

While the invention has been shown and described with reference to certain preferred embodiments thereof, it will be understood by those skilled in the art that various changes in form and details may be made thereto without departing from the spirit and scope of the invention as defined by the appended claims.

What is claimed is:

1. A system for lawful interception using a trusted third party in secure VoIP communication between a VoIP transmit terminal and a VoIP receive terminal, the system comprising:
a trusted third party that receives a master key request from the VoIP transmit terminal to generate a master key and transmits the generated master key to the VoIP transmit terminal and a key recovering system;
a key recovering system that receives a lawful interception request from a lawful interception requester to instruct a collection device on lawful interception, receives a secure packet from the collection device, receives the master key from the trusted third party, decrypts the secure packet with the master key and provides the decrypted packet to the lawful interception requester or provides the master key and the secure packet to the lawful interception requester; and
a collection device that collects the secure packet transmitted/received between the VoIP transmit terminal and the VoIP receive terminal in accordance with the lawful interception instruction received from the key recovering system and transmits the collected secure packet to the key recovering system.

2. The system according to claim 1, wherein the trusted third party performs additional functions of generating a session key with the mater key and transmitting the session key to the key recovering system, and
wherein the key recovering system receives the lawful interception request from the lawful interception requester to instruct the collection device on the lawful interception, receives the secure packet from the collection device, receives the session key from the trusted third party, decrypts the secure packet with the session key, and provides the decrypted packet to the lawful interception requester or provides the session key and the secure packet to the lawful interception requester.

3. The system according to claim 2, wherein the trusted third party comprises:
an encryption key generation unit that generates a master key in accordance with a master key request from the VoIP transmit terminal and generates a session key with the master key;
a storage unit that stores the master key and the session key generated by the encryption key generation unit;
a transmit unit that transmits the master key to the VoIP transmit terminal and transmits the session key to the key recovering system; and
a control unit that controls the respective elements constituting the trusted third party.

4. The system according to claim 3, wherein the control unit performs additional functions of key recovery request record management and monitoring management.

5. The system according to claim 1 or 2, wherein the key recovering system comprises:
a decryption unit that decrypts the secure packet received from the collection device using the master key or session key received from the trusted third party;
a storage unit that stores call information between the VoIP transmit terminal and the VoIP receive terminal, the call information being extracted from the packet decrypted by the decryption unit;
a transmit unit that receives the secure packet from the collection device, receives the master key or session key from the trusted third party and transmits the secure packet or decrypted packet to the lawful interception requester; and
a control unit that controls the respective elements constituting the key recovering system.

6. The system according to claim 5, wherein the call information comprises information about IDs of the VoIP transmit terminal and the VoIP receive terminal, IP/ports of the VoIP transmit terminal and the VoIP receive terminal, time at which a call is initiated and time at which the call is terminated.

7. The system according to claim 5, wherein the control unit performs additional functions of key recovery request record management and monitoring management.

8. A method for lawful interception using a trusted third party in secure VoIP communication between a VoIP transmit terminal and a VoIP receive terminal, the method comprising the steps of:
(a) instructing, at a key recovering system, a collection device on lawful interception in accordance with a lawful interception request from a lawful interception requester;
(b) at the trusted third party, receiving a master key request from the VoIP transmit terminal to generate a master key and transmitting the generated master key to the VoIP transmit terminal and a key recovering system;
(c) exchanging the master key and performing secure communication between the VoIP transmit terminal and the VoIP receive terminal;
(d) at the collection device, collecting a secure packet transmitted/received between the VoIP transmit terminal and the VoIP receive terminal and transmitting the secure packet to the key recovering system; and
(e) at the key recovering system, receiving the master key from the trusted third party, decrypting the secure packet with the received master key and providing the decrypted packet to the lawful interception requester.

9. The method according to claim 8, wherein the step of (c) comprises the steps of:
(c1) exchanging the master key between the VoIP transmit terminal and the VoIP receive terminal; and
(c2) generating a session key with the master key at each of the trusted third party, the VoIP transmit terminal and the VoIP receive terminal and then performing the secure communication between the VoIP transmit terminal and the VoIP receive terminal, and
wherein the step of (e) comprises the step of, at the key recovering system, receiving the session key from the trusted third party, decrypting the secure packet using the session key and providing the decrypted packet to the lawful interception requester.

10. The method according to claim 8 or 9, wherein the exchange of the master key between the VoIP transmit terminal and the VoIP receive terminal in the step of (c) comprises the steps of:
transmitting an INVITE message including the master key to the VoIP receive terminal from the VoIP transmit terminal; and
transmitting a response message to the INVITE message to the VoIP transmit terminal from the VoIP receive terminal.

11. The method according to claim 8, wherein the step of (e) comprises the step of, at the key recovering system, receiving the mater key from the trusted third key and providing the received master key and the secure packet received from the collection device to the lawful interception requester.

12. The method according to claim 9, wherein the step of (e) comprises the step of, at the key recovering system, receiving the session key from the trusted third key and providing the received session key and the secure packet received from the collection device to the lawful interception requester.

13. The method according to claim 11 or 12, wherein the exchange of the master key between the VoIP transmit terminal and the VoIP receive terminal in the step of (c) comprises the steps of:
transmitting an INVITE message including the master key to the VoIP receive terminal from the VoIP transmit terminal; and
transmitting a response message to the INVITE message to the VoIP transmit terminal from the VoIP receive terminal.
